(19) United States
(12) Patent Application Publication
(10) Pub. No.: US 2021/0223625 A1
(43) Pub. Date: Jul. 22, 2021

(54) REFLECTOR AND BACKLIGHT MODULE

(71) Applicant: WUHAN CHINA STAR OPTOELECTRONICS TECHNOLOGY CO., LTD., Wuhan, Hubei (CN)

(72) Inventors: Yunlong GUO, Wuhan, Hubei (CN); Gonghua ZOU, Wuhan, Hubeicn (CN)

(21) Appl. No.: 16/300,969

(22) PCT Filed: Aug. 7, 2018
(86) PCT No.: PCT/CN2018/099123

§ 371 Date: Nov. 13, 2018

(30) Foreign Application Priority Data
Jul. 25, 2018 (CN) 201810826870.2

(51) Int. Cl. G02F 1/13357

(52) U.S. Cl. CPC G02F 1/133605; G02F 2202/22

(57) ABSTRACT

A reflector includes a reflector body and a reflective coating layer arranged on the reflector body. The reflective coating layer includes a reflective layer and a first neutralizing layer. The first neutralizing layer is formed by an ion-exchange resin and configured to neutralize static electricity.

### BACKGROUND

### 1. Field of the Disclosure

The present disclosure relates to the technical field of a liquid crystal display (LCD), and more particularly, to a reflector and a backlight module.

### 2. Description of the Related Art

A liquid crystal display (LCD) device of the related art generally includes an LCD panel and a backlight module. A reflector of the backlight module includes a reflective layer and a substrate. Two common types of reflectors on the market are: white reflector and metallic reflector. Generally, each of the white reflector and the metallic reflector includes the substrate formed by PET material. The difference lies in the material of their reflective layers; that is, the reflective layer of the white reflector is formed by white TiO2, and the reflective layer of the metallic reflector is formed by metal with a good reflective effect. Because of the complexity of the process of forming reflective layers with semiconductor material TiO2, white reflectors are more expensive than metallic reflectors. In consideration of the cost of reflective layers, metallic reflectors are more likely to be used in production.

However, a liquid crystal panel with a metallic reflector is subjected to the interference of static electricity. Because there is no venting path, free electric charge accumulates on the surface of the metallic reflector, thereby causing damage to the wiring inside the liquid crystal panel and the entire system.

### SUMMARY

The present disclosure proposes a reflector to solve the technical problem that free electric charge accumulates on the surface of the reflector, thereby causing damage to the wiring inside a liquid crystal panel and the entire system.

According to a first aspect of the present disclosure, a reflector composes a reflector body and a reflective coating layer arranged on the reflector body. The reflective coating layer comprises a reflective layer and a first neutralizing layer. The first neutralizing layer is formed by an ion-exchange resin and configured to neutralize static electricity.

According to one embodiment, a hole is arranged on the reflector body. The hole is filled with a conductive material to form a conductor. A terminal of the conductor contacts the first neutralizing layer. A second neutralizing layer is coated on the other terminal of the conductor.

According to one embodiment, the reflective layer is formed by conductive metal material. The first neutralizing layer is arranged between the reflective layer and the reflector body.

According to one embodiment, the reflective layer is formed by silver or aluminum.

According to one embodiment, the hole penetrates the reflective layer. The first neutralizing layer is coated on the terminal of the conductor close to the reflective layer.

According to one embodiment, a thickness of the first neutralizing layer is the same as a thickness of the conductor.

According to one embodiment, a cross-sectional shape of the hole is circular, elliptical, or polygonal.

According to one embodiment, the conductor may be formed by aluminum or copper.

According to a second aspect of the present disclosure, a backlight module comprises a light source, a back plate, and a reflector as provided above.

According to one embodiment, the second neutralizing layer is arranged between the reflector body and the back plate, and the second neutralizing layer contacts the back plate.

The present disclosure brings the effects that free electric charge will not be accumulated on the surface of the reflector and cause damage to the wiring inside the liquid crystal panel and the entire system after free electric charge generated by the static electricity is neutralized in time with an ion-exchange resin.

### BRIEF DESCRIPTION OF THE DRAWINGS

In order to more clearly illustrate the embodiments of the present disclosure or related art, the following figures will be described in the embodiments are briefly introduced. It is obvious that the drawings are merely some embodiments of the present disclosure, those of ordinary skill in this field can obtain other figures according to these figures without paying the premise.

FIG. 1 illustrates a reflector according to an embodiment of the present disclosure.

FIG. 2 illustrates an arrangement of holes according to an embodiment of the present disclosure.

FIG. 3 illustrates a backlight module according to an embodiment of the present disclosure.

FIG. 4 illustrates a reflector according to another embodiment of the present disclosure.

Labels in Figures: 10 reflector body; 11 hole; 20 reflector: 30 first neutralizing layer; 40 second neutralizing layer, 50 conductors; 60 back plate.

### DETAILED DESCRIPTION OF THE EMBODIMENTS

In the disclosure, it is should be understood that spatially relative terms, such as “center”, “longitudinal”, “lateral”, “length”, “width”, “above”, “below”, “front”, “back”, “left”, “right”, “horizontal”, “vertical”, “top”, “bottom”, “inner”, “outer”, “clockwise”, “counterclockwise”, “axial”, “radial”, “circumferential”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. The spatially relative terms are not limited to specific orientations depicted in the figures. In addition, the term “first”, “second” are for illustrative purposes only and are not to be construed as indicating or imposing a relative importance or implicitly indicating the number of technical features indicated. Thus, a feature that limited by “first”, “second” may expressly or implicitly include at least one of the features. In the description of the present disclosure, the meaning of “plural” is two or more, unless otherwise specifically defined.

The present disclosure is directed to a silver reflector of the related art. Free electric charge easily accumulates on the surface of the silver reflector on condition of no static venting path. The consequence is that the wiring inside a liquid crystal panel and the entire system are both damaged. The present disclosure proposes a solution to the above-mentioned defect. Please refer to Embodiment 1 and Embodiment 2.

### Embodiment 1

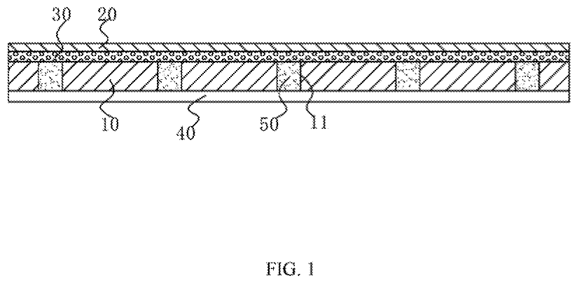

As illustrated in FIG. 1, a reflector includes a reflector body 10 and a reflective coating layer provided on the reflector body 10. The reflective coating layer includes a reflective layer 20 and a first neutralizing layer 30. The first neutralizing layer 30 is formed by an ion-exchange resin and configured to neutralize static electricity.

The substrate is formed by polyethylene terephthalate (PET) material. The PET material has a certain crystal orientation ability; in other words, the PET material has better film formability and better plasticity.

The ion-exchange resin is an insoluble polymer substance including a plurality of ionic groups such as an ion exchange resin, an ion exchange cellulose, an ion exchange gel, etc. The ion-exchange resin easily provides an equal amount of opposite electric charge to the electrostatic ions for neutralization, thereby achieving the effect of releasing free electric charge on the reflective layer 20, preventing free electric charge from accumulating on the surface of the reflector. The accumulation of free electric charge on the surface of the reflector may cause damage to the wiring inside a liquid crystal panel and the entire system.

The reflective layer 20 is formed by conductive metal material. The first neutralizing layer 30 is arranged between the reflective layer 20 and the reflector body 10. The first neutralizing layer 30 is arranged between the reflective layer 20 and the reflector body 10 to prevent the first neutralizing layer 30 from affecting reflection of light performance of the reflector. The reflective layer 20 has a good reflection effect. At the same time, the reflective layer 20 is electrically conductive. After free electric charge is produced, free electric charge is conducted to the first neutralizing layer 30 through the reflective layer 20, and free electric charge is neutralized by the ion-exchange resin arranged in the first neutralizing layer 30 to prevent free electric charge from accumulating on the surface of the reflector.

In a specific embodiment, a reflective layer 20 may also be arranged between a first neutralizing layer 30 and a reflector body 10. When free electric charge is produced due to static electricity, it is not necessary to conduct free electric charge to the first neutralizing layer 30 via the reflective layer 20. Accordingly, free electric charge is rapidly neutralized, and the accumulation of free electric charge is prevented.

The reflective layer 20 is formed by silver or aluminum. Silver and aluminum both feature good electrical conductivity. Therefore, the effect of the reflective layer 20 formed by silver or aluminum on reflection of light is good as well.

A hole 11 is arranged on the reflector body 10. The hole 11 extends away from the reflective layer 20 to penetrate the upper and lower sides of the reflector body 10. The hole 11 is filled with a conductive material to form a conductor 50. One terminal of the conductor 50 contacts the first neutralizing layer 30.

A second neutralizing layer 40 is coated on one terminal of the conductor 50 away from the reflective layer 20. If a large amount of free electric charge accumulates on the surface of the reflective layer 20 due to static electricity, the large amount of free electric charge on the surface of the reflective layer 20 is directed to the second neutralizing layer 40 through the conductor 50 for neutralization. Meanwhile, free electric charge on one side of the reflector body 10 away from the reflective layer 20 is neutralized via the second neutralizing layer 40, which prevents electric charge from accumulating on the surface of the reflector.

Specifically, the conductor so is formed by aluminum or copper. Aluminum and copper both feature good electrical conductivity and low cost, which can reduce production costs.

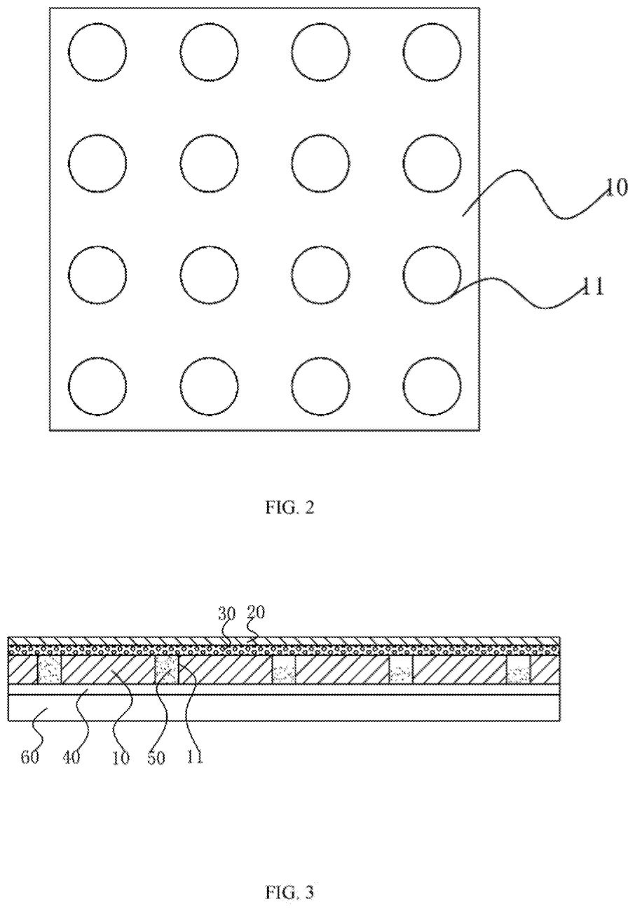

As illustrated in FIG. 2, a plurality of holes 11 are formed and evenly distributed on the reflector body 10. Each of the plurality of holes 11 is filled with a conductor 50.

In another embodiment, the cross-sectional shape of the hole 11 is circular. It is understood that the cross-sectional shape of a hole 11 may be elliptical or polygonal as well in a specific embodiment.

As illustrated in FIG. 3, a backlight module includes a light source, a back plate 60, and a reflector as introduced above.

The second neutralizing layer 40 is arranged between the reflector body 10 and the back plate 60. The second neutralizing layer 40 contacts the back plate 60. The back plate 60 is formed by a conductive metal. As the lifespan of the TCP device increases, if the first neutralizing layer 30 and the second neutralizing layer 40 are unable to perform the effect of electric charge neutralization, free electric charge produced due to the static electricity can be vented through the back plate 60 to prevent free electric charge from accumulating on the surface of the reflector, thereby extending the life cycle of the LCD device.

### Embodiment 2

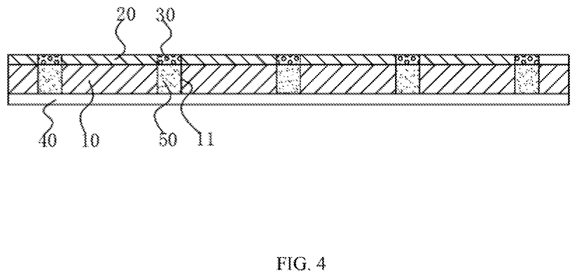

A reflector proposed by the second embodiment as illustrated in FIG. 4 is different from the reflector proposed by the first embodiment. The difference lies in the position of a first neutralizing layer 30.

Specifically, a hole 11 penetrates a reflective layer 20. The first neutralizing layer 30 is coated on an end surface of a conductor 50. After free electric charge is produced due to static electricity, free electric charge does not need to be conducted to the first neutralizing layer 30 through the reflective layer 20. Free electric charge produced due to static electricity is rapidly neutralized with the ion-exchange resin to prevent an accumulation of electric charge. At the same time, the first neutralizing layer 30 is merely coated on the end surface of the conductor 50, which helps to reduce the area occupied by the first neutralizing layer 30 and run down the influence on reflection of light. The reflective layer 20 and the first neutralizing layer 30 are not overlapped. Accordingly, the thickness of the reflector is reduced, resulting in a reduction in the overall thickness of a liquid crystal display (LCD) device.

Specifically, the thickness of the first neutralizing layer 30 is the same as the thickness of the conductor 50. The overall flatness of the reflective layer 20 is enhanced to reduce the effect on reflection of light.

The present disclosure brings the effects that free electric charge will not be accumulated on the surface of the reflector and cause damage to the wiring inside the liquid crystal panel and the entire system after free electric charge generated by the static electricity is neutralized in time with an ion-exchange resin.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

1. A reflector, comprising:
a reflector body;
a reflective coating layer, arranged on the reflector body;
wherein the reflective coating layer comprises a reflective layer and a first neutralizing layer; the first neutralizing layer is formed by an ion-exchange resin and configured to neutralize static electricity.

2. The reflector of claim 1, wherein a hole is arranged on the reflector body; the hole is filled with a conductive material to form a conductor; a terminal of the conductor contacts the first neutralizing layer; a second neutralizing layer is coated on the other terminal of the conductor.

3. The reflector of claim 2, wherein the reflective layer is formed by conductive metal material; the first neutralizing layer is arranged between the reflective layer and the reflector body.

4. The reflector of claim 3, wherein the reflective layer is formed by silver or aluminum.

5. The reflector of claim 2, wherein the hole penetrates the reflective layer; the first neutralizing layer is coated on the terminal of the conductor close to the reflective layer.

6. The reflector of claim 5, wherein a thickness of the first neutralizing layer is the same as a thickness of the conductor.

7. The reflector of claim 2, wherein a cross-sectional shape of the hole is circular, elliptical, or polygonal.

8. The reflector of claim 2, wherein the conductor may be formed by aluminum or copper.

9. A backlight module comprising:
a light source;
a back plate; and
a reflector, comprising:
a reflector body; and
a reflective coating layer, arranged on the reflector body;
wherein the reflective coating layer comprises a reflective layer and a first neutralizing layer; the first neutralizing layer is formed by an ion-exchange resin and configured to neutralize static electricity.

10. The backlight module of claim 9, wherein the second neutralizing layer is arranged between the reflector body and the back plate, and the second neutralizing layer contacts the back plate.
